(19) United States
(12) Patent Application Publication
(10) Pub. No.: US 2020/0034367 A1
(43) Pub. Date: Jan. 30, 2020

(54) RELATION SEARCH SYSTEM, INFORMATION PROCESSING DEVICE, METHOD, AND PROGRAM

(71) Applicant: NEC Corporation, Tokyo (JP)

(72) Inventors: Yuma IWASAKI, Tokyo (JP); Masahiko ISHIDA, Tokyo (JP); Akihiro KIRIHARA, Tokyo (JP); Koichi TERASHIMA, Tokyo (JP); Hiroko SOMEYA, Tokyo (JP); Ryohto SAWADA, Tokyo (JP)

(73) Assignee: NEC Corporation, Tokyo (JP)

(21) Appl. No.: 16/493,862

(22) PCT Filed: Mar. 6, 2018
(86) PCT No.: PCT/JP2018/008612

§ 371 Date: Sep. 13, 2019

(30) Foreign Application Priority Data
Mar. 13, 2017 (JP) 2017-047350

(51) Int. Cl. G06F 16/2455; G06N 20/00; G06F 16/25; G06N 3/08

(52) U.S. Cl. CPC G06F 16/24564; G06N 3/08; G06F 16/258; G06N 20/00

(57) ABSTRACT

A relation search system includes: a storage means (1) which stores a data set which includes a first-type data group and a second-type data group which are two types of data group that are acquired by different methods; a data adaptation means (2) which either corrects or reconstructs either first data which belongs to the first-type data group or second data which belongs to the second-type data group and which is associated with the first data, such that a divergence which arises between the first data and the second data because of the difference in the methods for the acquisition thereof is reduced; and a learning means (3) which, using the data set which includes the corrected or reconstructed data, carries out machine learning.

### TECHNICAL FIELD

The present invention relates to a relation search system, an information processing device, a relation search method, and a relation search program for searching for a relation between predetermined parameters indicated by data from a data set.

### BACKGROUND ART

In recent years, a technology called materials informatics has been attracting attention in the field of material development. The backgrounds thereof include that the advancement of material experimental techniques such as combinatorial techniques have made it possible to acquire a large amount of material experimental data in a short period of time, and the advancement of computer technology and the emergence of efficient computation techniques have made it possible to acquire a large amount of material computation data by using the first-principles computation, a molecular dynamics method, and the like.

Materials informatics is a generic term for a technology that performs material search by utilizing a technology (especially a data mining technology) realized by the information processing ability of a computer, such as a machine learning technology or an artificial intelligence (AI) technology, for such big data on materials. Herein, substances targeted for material search include not only new substances whose structures are unknown, but also substances that are known substances and have properties not paid attention at present.

As mentioned above, it has become possible to acquire the big data on materials, but it is impossible for humans to comprehensively grasp and analyze the big data. If relations among materials, which cannot be recognized by humans, can be discovered by managing many pieces of information on the materials, such as structures and properties, as a database and using the machine learning and the AI technologies, it is believed that the discovery may possibly lead to unexpected material development.

With regard to such materials informatics, for example, PTL 1 describes a method of searching for constitutive substance information on a novel material. In the method described in PTL 1, first, a plurality of physical property parameters related to a substance is stored in advance. Then, the database is accessed to extract various actual data for all the substances, and the actual data are organized by being associated with the plurality of physical property parameters, thereby confirming the existence of data not accumulated in the database. Then, virtual data is estimated by performing arithmetic operations on the confirmed unaccumulated data on the basis of the actual data. Then, a search map is generated by using the estimated virtual data and the actual data.

Moreover, NPL 1 describes an example of using machine learning for a method of estimating the material function of a predicted compound from quantitative data on the material function of the compound obtained by experiment and computation as an example of materials informatics. Furthermore, NPL 1 describes that, in order to enhance the accuracy of the prediction, it is effective to sequentially validate a structure/material prediction model (prediction model) by using independent data not utilized for the prediction, such as experimental data.

Further, NPL 2 describes a method of heterogeneous mixed learning as one example of the learning methods suitable for material search.

### CITATION LIST

### Patent Literature

PTL 1: Japanese Patent No. 4780554

### Non Patent Literature

NPL 1: Isao Tanaka, three others, “Searching for New Materials Based On Materials Informatics”, [online], Department of Materials Science and Engineering, Kyoto University, [Feb. 17, 2017 search], Internet <URL: http://cros.mtl.kyoto-u.ac.jp/_downloads/M-Info.pdf>

NPL 2: Ryohei Fujimaki, Satoshi Morinaga, “The Most Advanced Data Mining of the Big Data Era”, NEC Technical Journal Vol. 65 No. 2, September 2012, pp. 81-85

### SUMMARY OF INVENTION

### Technical Problem

Using big data on materials in a system for machine learning and AI analysis has the following problems. That is, there is a divergence between data obtained by experiment and data obtained by computation in many cases, and reasonable results cannot be obtained even if the analysis is performed by ignoring the existence of such a divergence.

One example of the divergence is due to crystal structure. For example, while the crystal structure is uniquely defined and computed in the first-principles computation, a plurality of crystal structures is often mixed in an actual substance. Even if the crystal structures are different, the constituent elements and the content ratios thereof are the same. Thus, even if such material experimental data and material computation data are input into machine learning as data on the same material, reasonable results cannot be obtained.

Note that the method described in PTL 1 is to only complement the actual data not existing in the database with an estimated value obtained by computation based on the existing actual data. Thus, PTL 1 is based on the premise that all actual data existing in the database are data indicating the values of the correct property parameters, and does not take into consideration that one data is adapted to another data for data already existing in the database by different acquisition methods.

In order to eliminate the divergence between the two types of data different in acquisition methods, it is necessary to know the method and conditions used to obtain the data and then adjust the data to absorb the difference. However, PTL 1 does not describe the suggestion of adjustment of the actual data to reduce such a divergence.

In addition, the method described in NPL 1 is to learn a prediction model of structure and physical property by using material experimental data and material computation data as well as to enhance the prediction accuracy by testing the prediction model by using the material experimental data. The validation target in NPL 1 is only a prediction model (internal parameters of the prediction model, and the like). Such a test is generally commonly used as one function of cross validation and does not convert the data itself (raw data) input into a learning apparatus. This is because such a test cannot be applied to the conversion of the raw data from a mathematical point of view.

Note that the above-described problems are considered to occur not only in the application of material search, but similarly occur also in, for example, the application of the analysis of the relation between corresponding parameters of the data included in a data set by utilizing a computation processing technology, such as machine learning, for the data set which is related to a certain matter, such as a certain phenomenon or a certain thing, and includes two types of data groups different in acquisition methods.

The present invention has been made in light of the above-mentioned problems, and an object thereof is to provide a relation search system, a relation search method and a relation search program capable of appropriately analyzing the relation between the corresponding parameters of data included in a data set even if the data set includes two types of data groups different in acquisition methods.

### Solution to Problem

A relation search system according to the present invention is characterized by including: a storage means which stores a data set which includes a first-type data group and a second-type data group which are two types of data group that are acquired by different methods; a data adaptation means which either corrects or reconstructs either first data which belongs to the first-type data group or second data which belongs to the second-type data group and which is associated with the first data, such that a divergence which arises between the first data and the second data because of the difference in the methods for the acquisition thereof is reduced; and a learning means which, using the data set which includes the corrected or reconstructed data, carries out machine learning.

An information processing device according to the present invention is characterized by including: a data adaptation means which either corrects or reconstructs, for a data set which includes a first-type data group and a second-type data group which are two types of data group that are acquired by different methods, either first data which belongs to the first-type data group or second data which belongs to the second-type data group and which is associated with the first data, such that a divergence which arises between the first data and the second data because of the difference in the methods for the acquisition thereof is reduced.

A relation search method, by an information processing device, according to the present invention is characterized by including: correcting or reconstructing, for a data set which includes a first-type data group and a second-type data group which are two types of data group that are acquired by different methods, either first data which belongs to the first-type data group or second data which belongs to the second-type data group and which is associated with the first data, such that a divergence which arises between the first data and the second data because of the difference in the methods for the acquisition thereof is reduced; and carrying out machine learning by using the data set which includes the corrected or reconstructed data.

A relation search program according to the present invention is characterized by causing a computer to execute processing of correcting or reconstructing, for a data set which includes a first-type data group and a second-type data group which are two types of data group that are acquired by different methods, either first data which belongs to the first-type data group or second data which belongs to the second-type data group and which is associated with the first data, such that a divergence which arises between the first data and the second data because of the difference in the methods for the acquisition thereof is reduced.

### Advantageous Effects of Invention

According to the present invention, it is possible to appropriately analyze the relation between the corresponding parameters of data included in the data set even if the data set includes two types of data groups different in acquisition methods.

### BRIEF DESCRIPTION OF DRAWINGS

FIG. 1 is a block diagram showing an example of a relation search system according to a first exemplary embodiment.

FIG. 2 is a flowchart showing one example of the operation of the relation search system of the first exemplary embodiment.

FIG. 3 is an explanatory diagram showing examples of the learning data.

FIG. 4 is a flowchart showing one example of the data adaptation processing by the data adaptation unit 2.

FIG. 5 is a block diagram showing a configuration example of a material development system of a second exemplary embodiment.

FIG. 6 is a block diagram showing a configuration example of the information processing device 21.

FIG. 7 is a flowchart showing an operation example of the information processing device 21 of the second exemplary embodiment.

FIG. 8 is a graph showing XRD data of FePt, CoPt and NiPt thin films generated in the experiments.

FIG. 9 is a graph showing the analysis results of the crystal structure by using the XRD data of Example 1.

FIG. 10 is an explanatory diagram showing a list of the corresponding parameters of the material computation data of Example 1.

FIG. 11 is an explanatory diagram showing a learned neural network model in Example 1.

FIG. 12 is a graph showing the results of DFT computation for a prototype material.

FIG. 13 is a graph showing the measurement results of the thermoelectric efficiency by using the anomalous Nernst effect of the prototype material (Co₂Pt₂Nx).

FIG. 14 is an explanatory diagram showing the learning results by heterogeneous mixed learning in Example 1.

FIG. 15 is a schematic block diagram showing a configuration example of a computer according to the exemplary embodiments of the present invention.

### DESCRIPTION OF EMBODIMENTS

### First Exemplary Embodiment

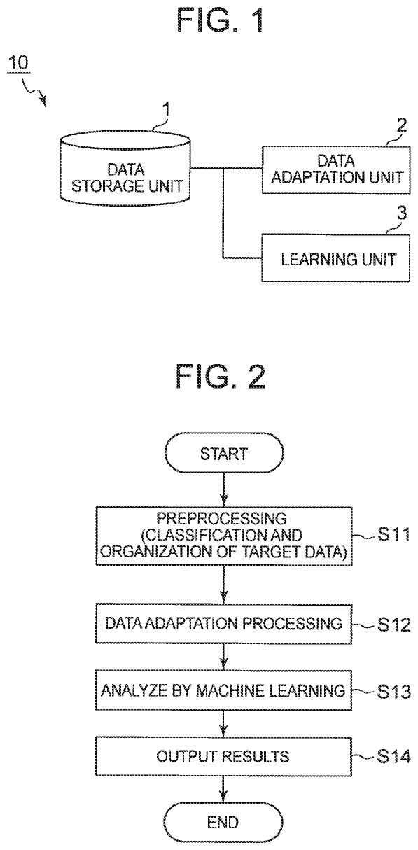

Hereinafter, exemplary embodiments of the present invention will be described with reference to the drawings. FIG. 1 is a block diagram showing an example of a relation search system according to the present exemplary embodiment. As shown in FIG. 1, a relation search system 10 includes a data storage unit 1, a data adaptation unit 2 and a learning unit 3.

The data storage unit 1 stores a data set including data corresponding to a parameter, which is a search target for the relation. In the present exemplary embodiment, the data storage unit 1 stores the data set including two types of data groups different in acquisition methods, such as a material experimental data group and a material computation data group.

Hereinafter, one of the two types of data groups included in the data set is referred to as a “first-type data group”, and the other is referred to as a “second-type data group” in some cases. Note that both the first-type data group and the second-type data group are only required to have one or more data. Moreover, in the data storage unit 1, each data (each data belonging to the first-type data group and each data belonging to the second-type data group) included in the data set is stored such that information on a data target (what the data is about), classification of target, data format, an acquisition method, acquisition conditions, acquisition date (data generation date) and a corresponding parameter (what data indicates), and the like is attached to each data as attribute information and these pieces of information can be identified.

The first-type data group may be, for example, a data group including data obtained in an environment where it is possible to directly or indirectly observe or measure an actual target (a phenomenon, a matter, a substance or the like), such as experiment. Moreover, the second-type data group may be, for example, a data group including data obtained by computation without requiring an actual target.

Note that the first-type data group and the second-type data group are not limited thereto, and, for example, both the first-type data group and the second-type data group may be data groups obtained by either experiment or computation. For example, the data set may include a first-type data group including data obtained by a first experimental method and a second-type data group including data obtained by a second experimental method. Moreover, for example, the data set may include a first-type data group including data obtained by a first computation method and a second-type data group including data obtained by a second computation method. Such cases are also equivalent to the data set including two types of data groups different in acquisition methods.

Although a case where each of the data included in the data set is data on a material is described as an example hereinafter, the data set stored in the data storage unit 1 is not limited thereto. For example, the data set may be a data set on one or more phenomena, may be data on one or more matters, or may be data on one or more substances.

When the data set is a data set on one or more materials, the data set may include, for example, data indicating a predetermined first property of a material of a target (hereinafter referred to as a target material) and data indicating two or more predetermined second properties different from the first property of the target material. Note that these are examples of the data set when attention is paid to the contents of each data. Therefore, the data indicating these properties can be included in any of the first-type data group and the second-type data group.

In the present exemplary embodiment, among the data on materials, data obtained by experiment on the materials is referred to as material experimental data, and data obtained by computation is referred to as material computation data. The material experimental data may be, for example, data on the property, structure, and composition of an actual material observed or measured by conducting an experiment on the material. Moreover, the material computation data may be, for example, data on the properties of a virtual material computed on the basis of a predetermined principle. Note that the data on the materials may be data described in the existing material databases or known papers. Furthermore, the data format may be a format of numerical values, such as scalars, vectors or tensors, and may be of images, moving images, character strings, sentences or the like.

The data adaptation unit 2 converts (corrects or reconstructs) certain data belonging to the first-type data group (hereinafter referred to as first data) or data belonging to the second-type data group and corresponding to the first data (hereinafter referred to as second data).

Herein, the relationship between the first data and the second data may be, for example, an analogous relationship of the mutual target material based on the same or a predetermined rule (e.g., the compositions match at a predetermined ratio or more, each raw materials meet a certain rule based on the periodic table, or the like). Herein, the identity of materials may be the identity of compositions. Note that, for the relationship between the first data and the second data, in addition to the case where one second data corresponds to one first data, there is considered a case where a plurality of second data corresponds to one first data, a case where one second data corresponds to a plurality of first data, or a case where a plurality of second data corresponds to a plurality of first data. In any cases, the data adaptation unit 2 converts at least one of one or more first data or at least one of one or more second data.

More specifically, the data adaptation unit 2 converts the first data or the second data so as to reduce a divergence occurred between the first data and the second data due to a difference in the respective acquisition methods.

Examples of the divergence include a divergence caused by, among the parameters used in the acquisition methods (variables, coefficients and preconditions used in computation formulas, preconditions in experiment, and the like), a parameter fixed or a parameter not taken into consideration in any one of the acquisition methods. In that case, for example, the data adaptation unit 2 determines the presence or absence of such a parameter between the first data and the second data and converts the first data or the second data on the basis of the difference in the parameters of both data if such a parameter exists. Note that the parameters used in the acquisition methods are called acquisition parameters hereinafter in some cases in order to distinguish the acquisition parameters from the corresponding parameters of each data (parameters desired to be analyzed for the relation, such as property parameters).

Moreover, other examples of the divergence include a divergence caused by the difference in the constitution of the target material and/or the difference in the ambient environmental conditions. In that case, for example, for each of the first data and the second data, the data adaptation unit 2 confirms the constitution of the target material and the ambient environmental conditions of the acquisition or the computation of each data. When the constitution or the conditions are different, the data adaptation unit 2 converts the first data or the second data on the basis of the difference in the constitution or the conditions in both data.

Herein, the constitution of the material includes the composition or structure of the material. Herein, the “composition” may be represented by the type of raw material and the ratio thereof. Moreover, the structure of the material includes the crystal structure or shape (e.g., thickness, length, or the like) of the material. Herein, the “crystal structure” may be, for example, represented by the type of long-range order and the ratio thereof. Note that examples of the “type of long-range order” are not particularly limited, but include ones by the classification of the Bravais lattice, by the prototype method, by the strukturbericht (ST) classification, by nomenclature such as Pearson symbol, by classic geometric classification such as space group, and a combination thereof. Note that the type of long-range order may be based on original classification besides the above and may include, for example, a type indicating absence of long-range order, such as amorphous.

For example, if the first data is material experimental data and the second data is material computation data, the data adaptation unit 2 compares the constitution of the target material of the first data with the constitution of the target material of the second data to confirm the presence or absence of a difference between the constitutions. Then, when there is a difference between the constitutions, the data adaptation unit 2 may correct or reconstruct the first data or the second data by using data obtained by other experiment or computation, a computation formula, or the like.

As a more specific example, when the crystal structure of the material is different between the first data and the second data, the data adaptation unit 2 may reconstruct one data so that the crystal structure (the type of long-range order and ratio) becomes the same as that of the other data. Herein, the data reconstruction includes combining a plurality of data into one, that is, generating one new data from a plurality of data, or decomposing one data, that is, generating two or more new data from one data. Furthermore, the data reconstruction includes combining a plurality of data into one and further decomposing, that is, generating two or more different data from a plurality of data. At this time, the data of the generation source may be still included in the data set or may be deleted from the data set. In any cases, when the data is converted, one or more new data indicating different contents for the parameters (properties and the like) the same as those in the data of the conversion source are added to the data group included the data of the conversion source.

Further, with respect to the examples of the divergence, the above-described difference in the ambient environmental conditions includes a difference in conditions relating to temperature, magnetic field or pressure, or being vacuum or not.

For example, if the first data is the material experimental data and the second data is the material computation data, the data adaptation unit 2 compares the temperature, magnetic field, pressure or the like during the generation or experiment of a substance, which were the acquisition conditions of the first data, with the temperature, magnetic field, pressure or the like presumed when the second data was acquired, and confirms the presence or absence of the difference therebetween. Then, when there is a difference therebetween, the data adaptation unit 2 may correct the first data or the second data by using data obtained by other experiment or computation, a computation formula, or the like.

A method of correcting the data includes a method of using, as a correction value, a value predicted by regression (supervised learning or theoretical computation) based on data obtained by other experiment or other computation. For example, there is considered a case where the temperature condition was 30° C. in the experiment to acquire the first data and the temperature condition was 20° C. in the computation to acquire the second data, and it is difficult to obtain the value of the desired parameter if the temperature were 30° C. in the computation. In such a case, the data adaptation unit 2 may predict the value of the parameter under the temperature condition of one data by using the results of supervised learning using data obtained by the same experiment using similar materials or the like or by other experiment or the like using the same material, or other theoretical computation and use that prediction value as a correction value for the other data. Although the above method has been described with temperature as an example, the same method can be applied to other ambient environmental conditions.

Moreover, for example, when the constitution of the target material cannot be identified from the attribute information, the data adaptation unit 2 may estimate the constitution of the target material by using other data (e.g., data indicating other properties) on the target material or a material similar thereto.

For example, when it is desired to identify the crystal structure (the type of long-range order and ratio thereof) of the target material of the material experimental data, X-ray diffraction (XRD) data indicating the X-ray diffraction patterns of a plurality of materials including the target material can be used for the identification. For example, the data adaptation unit 2 may fit the XRD data on the target material with an arbitrary curve to determine the crystal structure of the target material from the ratio of each structural peak area or peak height. Furthermore, for example, the data adaptation unit 2 may perform unsupervised learning, such as hard clustering or soft clustering, of XRD data on a plurality of materials including the target material to determine the crystal structure of each material from the results.

For example, when it is known in advance that the target material has a single crystal structure by the acquisition method thereof, the data adaptation unit 2 may use hard clustering, in which the data to be classified and the classification destination are in a one-to-one correspondence, to identify the type of the crystal structure possessed by the target material. On the other hand, when there is a possibility that the target material does not have a single crystal structure, the data adaptation unit 2 uses soft clustering to identify together the types of the crystal structures included in the target material and the component ratios thereof.

The learning unit 3 performs machine learning by using a data set including the data after the conversion by the data adaptation unit 2. As long as the machine learning performed by the learning unit 3 is algorithm that can construct the relation between the corresponding parameters of each data included in the data set, a specific learning method does not matter. Various learning methods can be considered, such as supervised learning, unsupervised learning, semi-supervised learning, and reinforcement learning. One example is a neural network which is one of general supervised learning. Furthermore, other examples include support vector machine, deep learning, Gaussian process, decision tree, random forest, and the like. Note that the learning method in machine learning is further preferably algorithm that can highly accurately solve non-linear sparse problems with white box, such as heterogeneous mixed learning shown in NPL 2.

Further, as a learning method of a data set, the learning unit 3 may perform machine learning using, for example, the above-described first property as an output parameter and the above-described second properties as input parameters.

At this time, an output data group, which is a data group corresponding to the output parameter, may be a data group indicating a desired property (equivalent to the above-described first property) in material search, such as thermoelectric efficiency or the like of one or more compounds or a complex. Moreover, is such a case, an input data group, which is a data group corresponding to the input parameters, may be a data group indicating the first property or a property other than the first property (equivalent to the above-described second properties) of each component constituting these compounds or complex. Herein, the property other than the first property may be a more primitive property that could be a candidate for the descriptor of the first property. Note that, from the viewpoint of wide material search by using machine learning, it is also considered to use as many properties as possible as learning parameters without particularly limiting the property other than the first property. Alternatively, in order to make it easier for humans to grasp the relation between the parameters, it is considered to, for example, intentionally limit the learning parameters by performing statistical processing.

The learning unit 3 also outputs information obtained by the machine learning. For example, the learning unit 3 may output information indicating the strength of the relation between the input parameters (two or more second properties) and the output parameter (the first property) obtained as a result of the learning described above. Herein, the relation between the input parameters and the output parameter is not limited to the relation between each of the input parameter and the output parameter and can include a relation between any combination of the two or more input parameters and the output parameter. That is, the learning unit 3 may output information indicating the strength of the relation between the first property and each of the two or more second properties or a combination thereof.

In the present exemplary embodiment, the data storage unit 1 is realized by, for example, a storage device. Moreover, the data adaptation unit 2 is realized by, for example, an information processing device. Furthermore, the learning unit 3 is realized by, for example, an information processing device, hardware in which a predetermined learning apparatus is mounted, and a network.

Next, the operation of the present exemplary embodiment will be described. FIG. 2 is a flowchart showing one example of the operation of the relation search system of the present exemplary embodiment. In the example shown in FIG. 2, first, the data adaptation unit 2 performs preprocessing (Step S11). For example, as the preprocessing, the data adaptation unit 2 classifies and organizes data for the learning data included in the data set stored in the data storage unit 1, and the like. Note that Step S11 can be omitted, for example, if these pieces of processing are performed in advance by a user. Herein, the learning data is data used for the learning by the learning unit 3. All the data included in the data set may be used as the learning data, or data that is designated by the user or meets a predetermined condition from among the data included in the data set may be used as the learning data.

For example, as the data classification processing, the data adaptation unit 2 roughly divides (classifies) the learning data according to the acquisition methods thereof. Accordingly, it is specified whether the learning data belongs to the first-type data group or the second-type data group.

Further, for example, as the data organization processing, the data adaptation unit 2 classifies the learning data belonging to the data groups according to the target thereof in each of the first-type data group and the second-type data group. Accordingly, the target material of each learning data is specified in each data group.

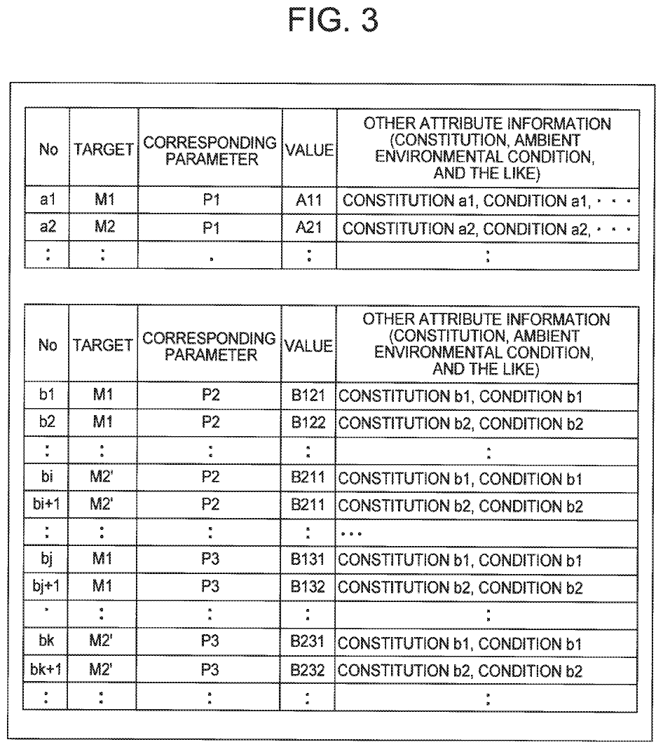

FIG. 3 is an explanatory diagram showing examples of the learning data after the data organization mentioned above. Note that the top of FIG. 3 is an explanatory diagram showing an example of the learning data belonging to the first-type data group, and the bottom of FIG. 3 is an explanatory diagram showing an example of the learning data belonging to the second-type data group. In these examples, each of the learning data has an identifier (“No” in the drawing), information indicating the target, information indicating the target parameter, and information indicating the constitution and the ambient environmental condition as other attribute information, in addition to the value of the corresponding parameter of the learning data.

For example, as an example of the learning data belonging to the first-type data group, the top of FIG. 3 shows learning data “a1” in which the target is “M1”, the corresponding parameter is “P1”, the value is “A11”, the constitution is “constitution a1”, and the ambient environmental condition is “condition a1”. Herein, the corresponding parameter is a corresponding parameter (property parameter) of the data. Moreover, for example, as an example of the learning data belonging to the second-type data group, the bottom of FIG. 3 shows learning data “b1” in which the target is “M1”, the corresponding parameter is “P2”, the value is “B121”, the constitution is “constitution b1”, and the ambient environmental condition is “condition b1”. Note that the bottom of FIG. 3 also shows learning data “b2” in which the target and the corresponding parameters are the same as those of the learning data “b1”, but both data are examples in which the constitutions and/or the conditions are different.

Next, the data adaptation unit 2 performs data adaptation processing (Step S12). In Step S12, the data adaptation unit 2 corrects or reconstructs the data so as to reduce the above-mentioned divergence between the first data and the second data.

Next, the learning unit 3 performs analysis by the machine learning (Step S13). In Step S13, the learning unit 3 performs the machine learning by using the data set including the data after the correction or reconstruction by the data adaptation unit 2, and outputs the information obtained by the machine learning.

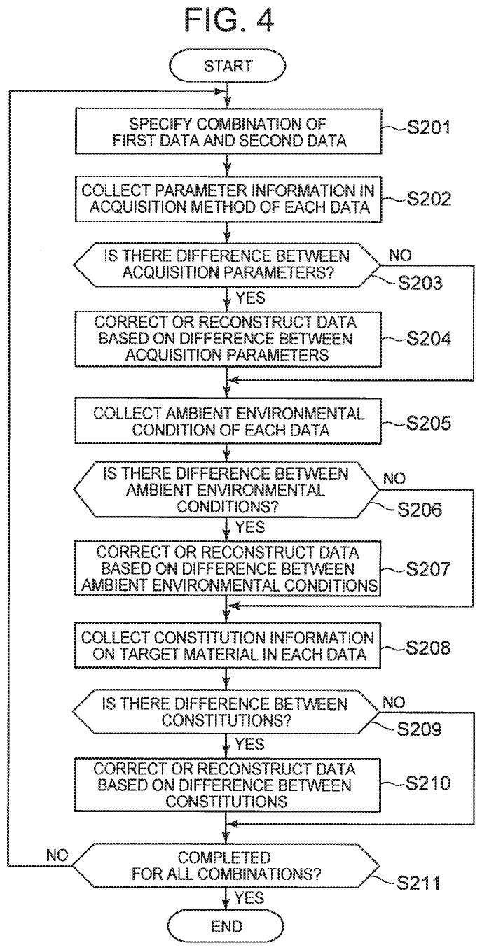

Next, the data adaptation processing in Step S12 will be described in more detail. FIG. 4 is a flowchart showing one example of the data adaptation processing by the data adaptation unit 2. As shown in FIG. 4, first, the data adaptation unit 2 specifies a set of the first data and the second data (Step S201). For example, the data adaptation unit 2 takes out and sets one learning data from the first-type data group as the first data and takes out and sets learning data corresponding to the first data from the second-type data group as the second data. For example, when the data adaptation unit 2 selects the learning data “a1” in the example shown in FIG. 3 as the first data, the learning data (e.g., the learning data “b1,” “b2”, or the like) with the same target “M1” may be selected from the second-type data group as the second data. In this way, the combination of the first data and the second data, which is an adaptation target, is specified.

Next, for the first data and the second data of the specified combination, the data adaptation unit 2 collects parameter information which is information on the acquisition parameters of the respective data (Step S202). In Step S202, the type and value of the parameter (acquisition parameter) used to acquire (observe, measure, compute, or the like) each data, and the presence or absence of a fixed parameter, and the like are acquired. Note that the parameter information may be designated by the user or may be stored in advance in a predetermined storage device in association with an identifier or the like of the acquisition method.

Next, the data adaptation unit 2 determines whether or not there is a difference between acquisition parameters of the first data and the second data on the basis of the collected parameter information on each data (Step S203). The data adaptation unit 2 may determine the difference on the basis of, for example, the number, type, contents or the like of the acquisition parameters. If there is a difference between the acquisition parameters (Yes in Step S203), the first data or the second data is corrected or reconstructed on the basis of the difference (Step S204). In a case where the parameter information could not have been collected, there is no difference between the parameters, or other matching data exists even if there is a difference, the processing directly proceeds to Step S205. Note that the processing may directly proceed to Step S205 even when the correction method or the reconstruction method cannot be specified in Step S204.

In Step S205, the data adaptation unit 2 collects the ambient environmental conditions for the first data and the second data of the specified combination. The ambient environmental conditions may be designated by the user or may be stored in advance in a predetermined storage device in association with an identifier or the like of the data.

Next, the data adaptation unit 2 determines whether or not there is a difference between the ambient environmental conditions of the first data and the second data on the basis of the collected ambient environmental conditions of the respective data (Step S206). If there is a difference (Yes in Step S206), the first data or the second data is corrected or reconstructed on the basis of the difference (Step S207). In a case where the ambient environmental conditions could not have been collected, there is no difference between the ambient environmental conditions, or other matching data exists even if there is a difference, the processing directly proceeds to Step S208. Note that the processing may directly proceed to Step S208 even when the correction method or the reconstruction method cannot be specified in Step S207.

In Step S208, the data adaptation unit 2 collects the constitution information indicating the composition, structure, shape, and the like of the target for the first data and the second data of the specified combination. The collection of the constitution information may be designated by the user, or the one stored in advance in a predetermined storage device in association with an identifier or the like of the data may be read out.

Next, the data adaptation unit 2 determines whether or not there is a difference between constitutions of the first data and the second data on the basis of the collected constitution information on each data (Step S209). If there is a difference (Yes in Step S209), the first data or the second data is corrected or reconstructed on the basis of the difference (Step S210). In a case where the constitution information could not have been collected, there is no difference between the constitutions, or other matching data exists even if there is a difference, the processing directly proceeds to Step S211. Note that the processing may directly proceed to Step S211 even when the correction method or the reconstruction method cannot be specified in Step S210.

In Step S211, determined is whether or not the above-described operation (Steps S202 to S210) has been completed for all combinations of the first data and the second data in the learning data. If the operation has been completed for all combinations (Yes in Step S211), the processing ends. If the operation has not been completed (No in Step S111), the processing returns to Step S201, and the same operation is performed on the combination for which the operation is not completed.

Note that the example, in which the data adaptation unit 2 performs all of the data adaptation processing based on the difference between the parameters (Steps S202 to S204), the data adaptation processing based on the ambient environmental conditions (Steps S205 to S207) and the data adaptation processing based on the constitutions (Steps S208 to S210), has been described above, but the data adaptation unit 2 is only required to perform at least one of these pieces of processing. Note that the user may designate which adaptation processing to perform.

As described above, according to the present exemplary embodiment, since the divergence caused the difference between the acquisition methods can be reduced before the machine learning is performed, reasonable results can be obtained by subsequent machine learning. Therefore, it is possible to appropriately analyze the relation between the corresponding parameters of the data included in the data set even if the data set includes two types of data groups different in acquisition methods.

### Second Exemplary Embodiment

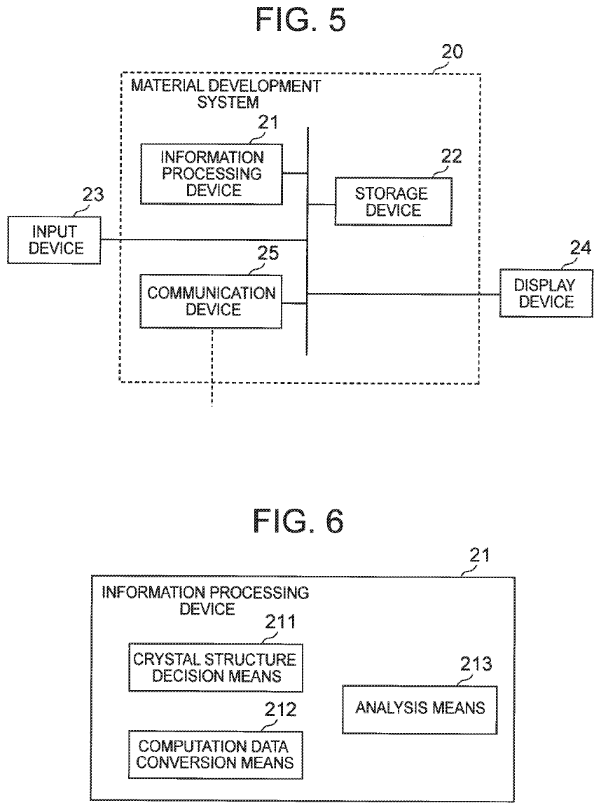

Next, a second exemplary embodiment of the present invention will be described. FIG. 5 is a block diagram showing a configuration example of a material development system of the second exemplary embodiment. Note that the material development system shown in FIG. 5 is a system that analyzes big data on materials by using machine learning and AI, and is an example in which the relation search system of the first exemplary embodiment is applied to the field of the material development.

As shown in FIG. 5, a material development system 20 includes an information processing device 21, a storage device 22, an input device 23, a display device 24, and a communication device 25 that communicates with the outside. Note that each device is connected to each other.

Herein, the information processing device 21 corresponds to the data adaptation unit 2 and the learning unit 3 of the first exemplary embodiment. Moreover, the storage device 22 corresponds to the data storage unit 1 of the first exemplary embodiment.

The storage device 22 is, for example, a storage medium such as a nonvolatile memory and stores various data used in the present exemplary embodiment. The storage device 22 of the present exemplary embodiment stores, for example, the following data.
Program for processing operation by the information processing device 21 and the like
Machine learning program for supervised learning, unsupervised learning, semi-supervised learning, reinforcement learning, or the like
A plurality of material experimental data obtained by the first-principles computation, a computation program for molecular dynamics or the like, a combinatorial method, and the like
A plurality of material computation data obtained by the first-principles computation, a molecular dynamics method, and the like
Data analyzed by machine learning

Note that the material computation data stored in the storage device 22 may be obtained by computation in the material development system 20 provided with a machine learning function, or may be acquired from an external database. The communication device 25 is linked to an external material database, experimental device and the like, and the material database and the experimental device may be accessed from the present system to control.

The input device 23 is an input device, such as a mouse or a keyboard and accepts an instruction from a user. The display device 24 is an output device such as a display and displays information obtained by the present system.

FIG. 6 is a block diagram showing a more detailed configuration example of the information processing device 21. As shown in FIG. 6, the information processing device 21 may include crystal structure decision means 211, computation data conversion means 212, and analysis means 213. Note that the crystal structure decision means 211 and the computation data conversion means 212 correspond to the data adaptation unit 2 of the first exemplary embodiment. Moreover, the analysis means 213 corresponds to the learning unit 3 of the first exemplary embodiment.

The crystal structure decision means 211 decides the crystal structure (especially the ratio) of a target material of the designated data from crystal structure information such as XRD data.

On the basis of the crystal structure decided by the crystal structure decision means 211, the computation data conversion means 212 converts (corrects or reconstructs) the material computation data so as to reduce a divergence between the material computation data and the material experimental data for that target material.

The analysis means 213 performs analysis by machine learning and AI using the material experimental data group and the material computation data group including the material computation data after the conversion by the computation data conversion means 212.

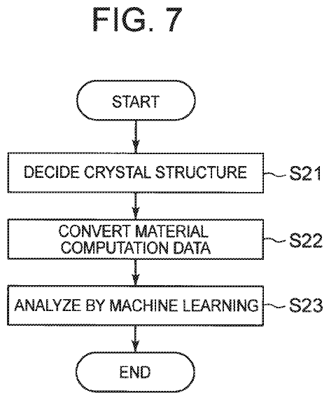

Next, the operation of the present exemplary embodiment will be described. FIG. 7 is a flowchart showing an operation example of the information processing device 21 of the present exemplary embodiment.

In the example shown in FIG. 7, first, the crystal structure decision means 211 decides the crystal structure (the type of long-range order and the ratio thereof) of each material as the target material of the material experimental data (Step S21). As mentioned above, the crystal structure decision means 211 may fit the XRD data with an arbitrary curve and determine the crystal structure from the ratio of each structural peak area and peak height or determine the crystal structure by utilizing unsupervised learning such as hard clustering or soft clustering.

Next, the computation data conversion means 212 converts the material computation data on the basis of the crystal structure obtained in Step S21 (Step S22).

Now, suppose that the crystal structure of the target material “M1” of the material experimental data includes a face-centered cubic lattice (fcc), a body-centered cubic lattice (bcc) and a hexagonal closest packed lattice (hcp), and their respective ratios are decided as A_{fcc}, A_{bcc} and A_{hcp}. Herein, A_{fcc}+A_{bcc}+A_{hcp}=1. Moreover, suppose that material computation data is obtained by computation on the premise of a single crystal structure. Furthermore, as data of the single crystal structure of that target material “M1”, there are material computation data indicating the values of the magnetic moments obtained by the first-principles computation for the respective types, and the respective values were M_{fcc}, M_{bcc} and M_{bcp}.

In such a case, the computation data conversion means 212 reconstructs the material computation data so as to reduce the divergence caused by the difference in crystal structure between the material computation data and the material experimental data of the same composition. In this example, the computation data conversion means 212 performs the following conversion to make a value of a certain property (more specifically, the magnetic moment) of the material computation data acquired under the condition of the single crystal structure close to a value of the property of the crystal structure of the material experimental data. That is, with the ratios as weights, the material computation data of the single crystal structure for the respective crystal lattices included in the crystal structure of the material experimental data are added together to generate (reconstruct) new material computation data indicating a property value for the crystal structure of a complex. In this case, a magnetic moment Mc after the reconstruction is expressed by, for example, the following formula.

Mc=A_{fcc}M_{fcc}+A_{bcc}M_{bcc}+A_{hcp}M_{hcp} (1)

However, the above method is merely an example, and the method of conversion processing (data adaptation processing) by the computation data conversion means 212 is not limited thereto.

Next, the analysis means 213 performs machine learning using the material computation data and the material experimental data to analyze the relation between the parameters of the respective data (Step S23). At this time, the analysis means 213 uses the material computation data after the conversion instead of the material computation data which is the conversion source in Step S23. Various machine learning techniques can be considered, such as supervised learning, unsupervised learning, semi-supervised learning, and reinforcement learning, but machine learning in the present exemplary embodiment is not particularly limited.

As described above, according to the present exemplary embodiment, the divergence between the material experimental data on materials, such as compounds and complexes, which are difficult to obtain by computation, and the material computation data on a premise of relatively simple constitution, such as composition, crystal structure and shape is reduced, then the machine learning can be performed. As a result, more reasonable learning results can be obtained. Therefore, by utilizing the present system to, for example, analyze an enormous amount of data, it is possible to obtain information that can be utilized for higher functional material development, including obtaining new information on a relation between parameters of a material, which humans cannot recognize, and the like.

Note that the example, in which the crystal structure of the target material of the material experimental data is analyzed to convert the material computation data, has been shown in the above-described example, but the analysis target is not limited to the crystal structure. For example, the analysis target may be the composition (type and ratio of raw materials including additives and the like), the shape (conditions of thickness and width) or the ambient environmental conditions (e.g., temperature, magnetic field, pressure, vacuum condition, and the like). Moreover, although the example, in which the material computation data of the target material is reconstructed on the basis of the material computation data of material the same as the target material of material experimental data, has been described above, it is also possible to reconstruct the material computation data of the target material the same as the target material of the material experimental data by using, for example, material data (can be computation data or experimental data) in which some raw materials, such as an additive, are different.

### EXAMPLE 1

Next, an example, in which the material development system of the second exemplary embodiment is used in development of a thermoelectric material, will be shown. Herein, development of an anomalous Nernst material which performs thermoelectric power generation by using an anomalous Nernst phenomenon will be described. The anomalous Nernst phenomenon is a phenomenon in which a voltage is generated in the z direction when a thermal gradient is applied to the y direction of a material magnetized in the x direction.

Now, with regard to three types of alloy thin film having the respective compositions of Fe₁₋ₓPtₓ, Co₁₋ₓPtₓ and Ni₁₋ₓPtₓ generated on a Si substrate, XRD data at different composition ratios, thermoelectric efficiency data of the anomalous Nernst effect at different composition ratios, and each data obtained from the first-principles computation at different composition ratios are stored in a storage device 22. Herein, x represents a platinum Pt content ratio and is any integer from 0 to 99.

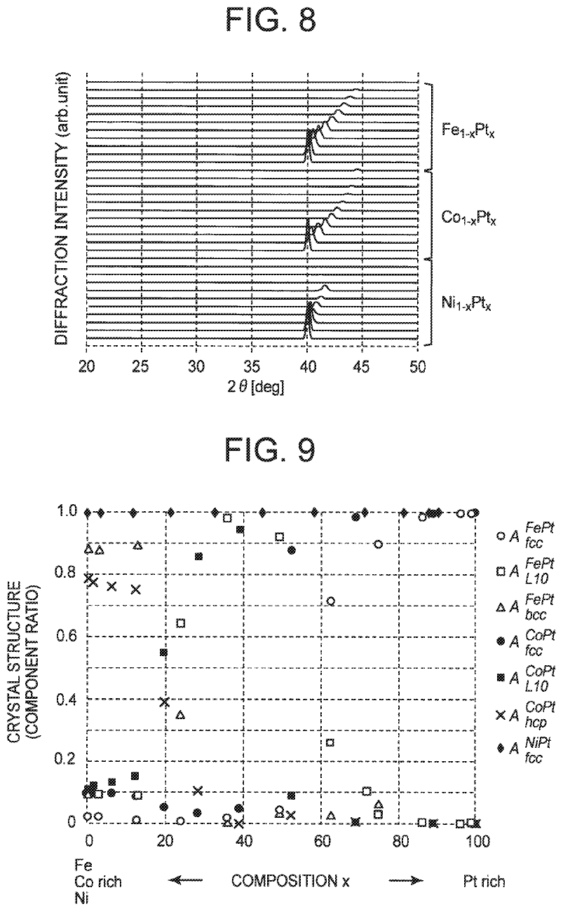

FIG. 8 shows the XRD data of each composition indicated by a set of constituent elements and composition ratios. In Step S21, the crystal structure is decided from these XRD data. In this example, non-negative matrix factorization (NMF), which is one of unsupervised learning, is used. By analyzing each XRD data with NMF, it was found that Fe₁₋ₓPtₓ, Co₁₋ₓPtₓ and Ni₁₋ₓPtₓ are each divided into three structures and the total of four types (fcc, bcc, hcp and L1₀) exist for the type of structure (crystal structure). FIG. 9 is a graph showing the analysis results of the crystal structure for each composition by using the XRD data. As can be seen from such analysis results, for example, the material of Co₈₁Pt₁₉ generated in the experiment is a material including about 55% of the L1₀ structure, about 40% of the hcp structure and about 5% of the fcc structure as the crystal structures.

Moreover, in Step S22, the material computation data of each composition is converted on the basis of the component ratio data indicating the types and ratios of the structures in the crystal structure of each composition thus obtained.

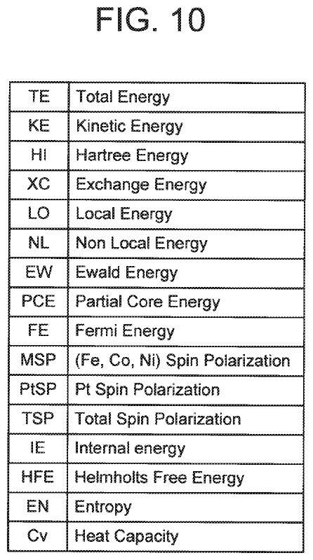

A list of the corresponding parameters of the material computation data of this example and the abbreviations thereof is shown in FIG. 10. Note that all the material computation data in this example were obtained from the first-principles computation. Each item (corresponding parameter) is computed for each structure (fcc, bcc, hcp and L1₀) forming a crystal structure of each composition.

In this example, such material computation data for each structure of each composition is assigned to the formula (1) to reconstruct the material computation data for the complex of each composition. For example, suppose that it was found from FIG. 9 that the component ratios of Co₈₁Pt₁₉, which is the target material of the material experimental data, are 5%, 0%, 40% and 55% for fcc, bcc, hcp and L10, respectively. Furthermore, suppose that values of the material computation data in each structure of Co₈₁Pt₁₉, which indicate the total energy (TE) included in the material computation data group, are TE_{fcc}, TE_{bcc}, TE_{L10} and TE_{hcp}. In that case, total energy TE_{C}, which is the value of the material computation data after the reconstruction (the material computation data in the complex of the same composition as in the material experimental data), is computed by a formula (2).

TE_{C}=0.05*TE_{fcc}+0*TE_{bcc}+0.4*TE_{hcp}+0.55*TE_{L10} (2)

Other data obtained from the first-principles computation are similarly converted.

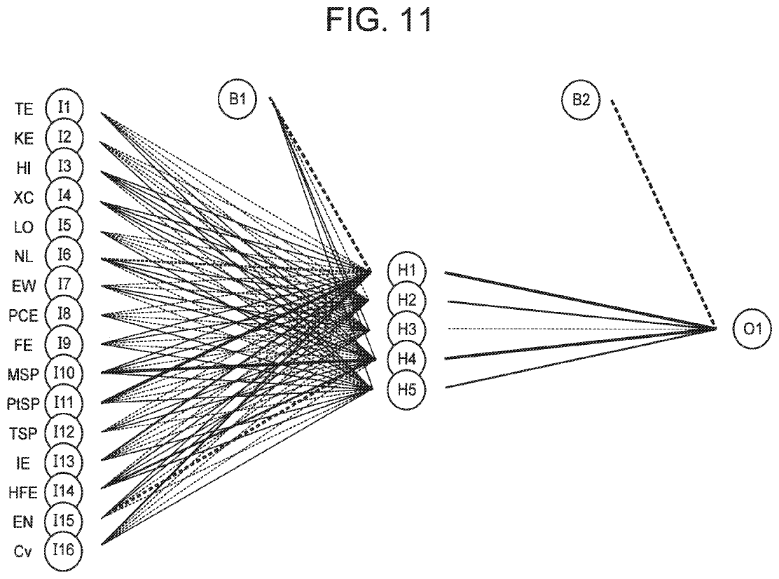

Further, in Step S23, the material computation data thus obtained by the reconstruction and the material experimental data (the thermoelectric efficiency data by the anomalous Nernst effect obtained in the experiment) are analyzed by machine learning. Herein, regression is performed by using a neural network, which is one of simple supervised learning. In this example, as shown in FIG. 11, the material computation data is set in an input unit, the material experimental data is set in an output unit, and learning is performed by the neural network.

Note that, when the analysis is performed without Steps S22 and S23, the crystal structure of the target material is different between the material experimental data and the material computation data so that a reasonable neural network model was not generated. However, in this example, reasonable results were obtained as shown below.

FIG. 11 visualizes the learned neural network model in this example. In FIG. 11, circles represent nodes. Note that nodes “I1” to “I16” each represent an input unit. Moreover, nodes “H1” to node “H5” represent hidden units. Furthermore, nodes “B1” and “B2” represent bias units. Further, a node “O1” represents an output unit. In addition, the paths connecting each node represent the respective links of the nodes. Each of these nodes and the connection relationships thereof mimic the firing of neurons in the brain. Note that the line thicknesses of the paths correspond to the strengths of the links, and the line types correspond to the reference signs of the links (the solid lines are positive, and the broken line are negative).

The strengths of the relations can be seen from the strengths of paths from the corresponding parameters (input parameters) of each material computation data leading to the thermoelectric efficiency (output parameter) by the anomalous Nernst effect in the learning results shown in FIG. 11. That is, the strongest among these paths is from the node “I11” to the node “O1” via the node “H1”, and the reference signs thereof are positive (solid lines). This indicates that there is a strong positive correlation between the spin polarization of the Pt atoms (PtSP) and the thermoelectric efficiency by the anomalous Nernst effect.

The fact “there is a positive correlation between the spin polarization of the Pt atoms and the thermoelectric efficiency by the anomalous Nernst effect” cannot be explained by the current solid-state physics. However, by using this correlative relationship obtained by the learning results with the present system, a thermoelectric material has been able to be generated by a more efficient anomalous Nernst effect.

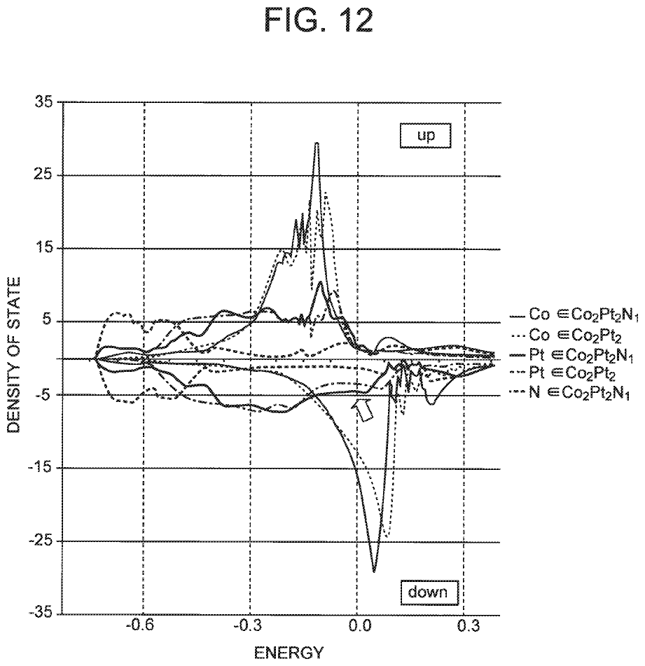

FIG. 12 shows the computation results of density of state (DOS) by the density function theory (DFT) of two types of materials containing Pt. Note that the two types of materials are Co₂Pt₂ (hereinafter referred to as Material 1) and Co₂Pt₂N (hereinafter referred to as Material 2) generated by inserting nitrogen N into Material 1. As can be seen from these results, the spin polarization of the Pt atoms is improved by inserting nitrogen into Material 1 (see the outlined arrow in the drawing).

Since the fact “there is a positive correlation between the spin polarization of the Pt atoms and the thermoelectric efficiency by the anomalous Nernst effect” is known from the results of the machine learning by the present system, the thermoelectric efficiency by the anomalous Nernst effect is expected to be higher in Material 2 than Material 1.

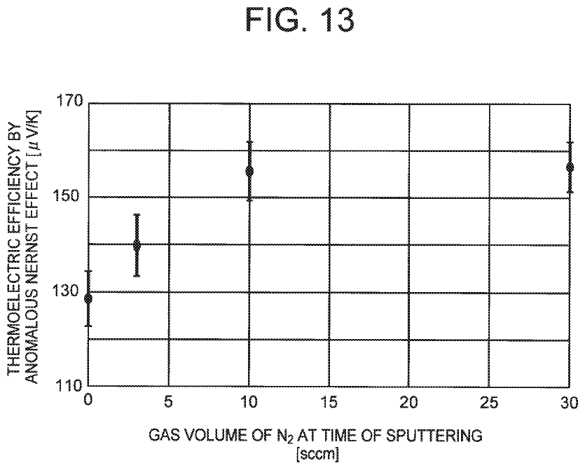

Material 2 (Co₂Pt₂Nx) was actually generated, and the thermoelectric efficiency by the anomalous Nernst effect was evaluated. The results are shown in FIG. 13. Note that the material was generated by a sputtering method, and the partial pressure of nitrogen N was changed at that time. As can be seen from FIG. 13, the greater the partial pressure of nitrogen N, the better the thermoelectric efficiency by the anomalous Nernst effect.

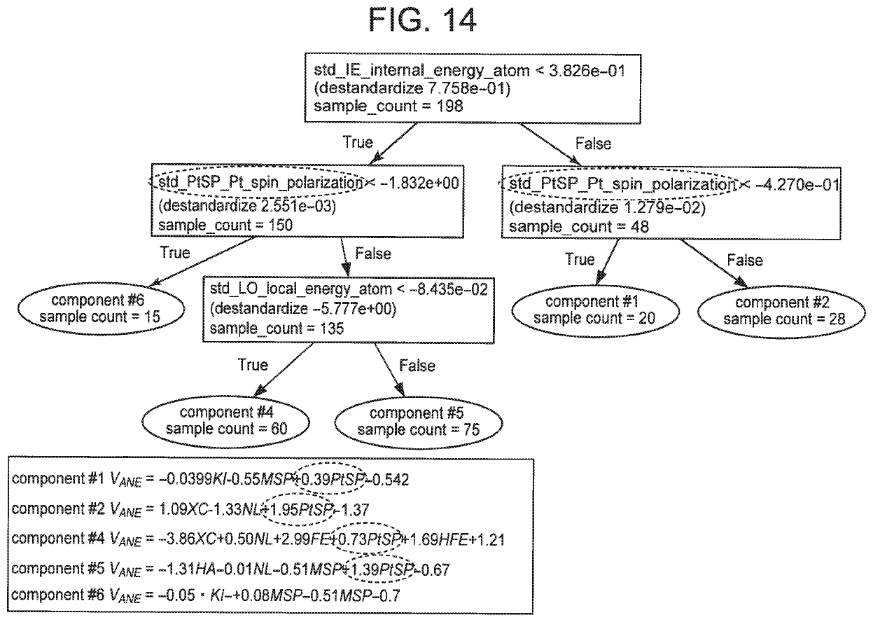

Although the example, in which the neural network is used as the learning method, has been described above, the learning method is not limited to the neural network. FIG. 14 shows the learning results when the learning method in Step S23 is changed to heterogeneous mixed learning.

The heterogeneous mixed learning is one of the learning methods that can solve sparse nonlinear problems with white box. Herein, more specifically, sparse represents a situation in which the number of samples of data (the number of material data in the above-described example) is fewer than the number of parameters (explanatory variables, such as TE, KI and Cv in the above-described example). Moreover, the white box indicates that humans are able to see and understand the relations in the learning apparatus. Many of the problems to be solved by material search are sparse and nonlinear. By using a learning method that can solve such problems with the white box, it is possible to know the strengths of the relations between the input parameters and the combination thereof (equivalent to the hidden units in the neural network) and the output parameters. Thereupon, for example, humans can know which parameter to focus on and what to do next (what kind of material should be made). Thus, such a learning method is suitable for material search.

FIG. 14 visualizes the inside of the learning apparatus obtained when the part using the neural network in the above-described example is replaced with the heterogeneous mixed learning. In the heterogeneous mixed learning, “case division” is performed in the quadrangles in the drawing, and “regression formulas” are generated at the destinations of the lines (ellipses). According to FIG. 14, it can be seen that PtSP appears often in both “case division” and “regression formulas” as indicated by the portions surrounded by the dotted circles. This shows that PtSP plays an important role in the thermoelectric efficiency (V_{ANE}). Thus, according to the present system, it can be seen that reasonable learning results are also obtained in the heterogeneous mixed learning by adapting the computation data to the experimental data.

Moreover, although the example, in which the thermoelectric efficiency using the anomalous Nernst effect was improved by the material development system according to the present invention, has been described above, the method of this example can also be applied to other properties, development of substances other than solid, and analysis of a target (a phenomenon or the like) other than substances, as a matter of course.

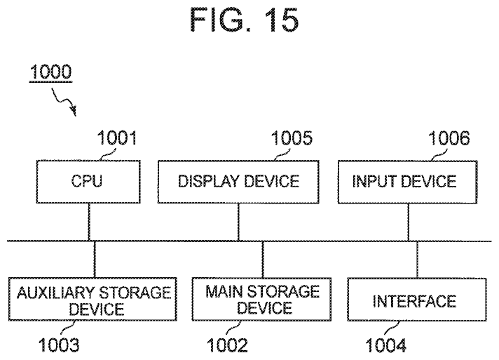

Next, a configuration example of a computer according to the exemplary embodiments of the present invention will be shown. FIG. 15 is a schematic block diagram showing the configuration example of the computer according to the exemplary embodiments of the present invention. A computer 1000 includes a CPU 1001, a main storage device 1002, an auxiliary storage device 1003, an interface 1004, a display device 1005 and an input device 1006.

Each device of the above-mentioned relation search system and material development system may be mounted in, for example, the computer 1000. In that case, the operation of each device may be stored in the format of a program in the auxiliary storage device 1003. The CPU 1001 reads out the program from the auxiliary storage device 1003, expands the program in the main storage device 1002, and carries out the predetermined processing in the above-described exemplary embodiments in accordance with the program.

The auxiliary storage device 1003 is one example of a non-transitory tangible medium. Other examples of non-transitory tangible media include magnetic disks, magneto-optical disks, CD-ROMs, DVD-ROMs, semiconductor memories, and the like, which are connected via the interface 1004. Furthermore, when this program is distributed to the computer 1000 by a communication line, the computer 1000 may expand the distributed program in the main storage device 1002 and execute the predetermined processing in the above-described exemplary embodiments.

Further, the program may be for realizing some of the predetermined processing in each exemplary embodiment. Moreover, the program may be a difference program that realizes the predetermined processing in the above-described exemplary embodiments in combination with other programs already stored in the auxiliary storage device 1003.

The interface 1004 transmits and receives information to and from other devices. Furthermore, the display device 1005 presents the information to the user. Further, the input device 1006 accepts input of information from the user.

Moreover, depending on the processing contents in the exemplary embodiments, some elements of the computer 1000 can be omitted. For example, if the device does not present the information to the user, the display device 1005 can be omitted.

Furthermore, some or all of the respective constituents of the respective devices are carried out by a general-purpose or dedicated circuit (circuitry), a processor, or the like, or a combination thereof. These may be constituted by a single chip or may be constituted by a plurality of chips connected via a bus. Further, some or all of the respective constituents of the respective devices may be realized by a combination of the above-mentioned circuits or the like and the program.

When some or all of the respective constituents of the respective devices are realized by a plurality of information processing devices, circuits, and the like, the plurality of information processing devices, circuits, and the like may be arranged in a centralized manner or may be arranged in a distributed manner. For example, the information processing devices, circuits, and the like may be realized as a form in which each is connected via a communication network, such as a client and server system, a cloud computing system, or the like.

Note that the above-described exemplary embodiments can also be described as the following supplementary notes.

### (Supplementary Note 1)

A relation search system including:

a storage means which stores a data set which includes a first-type data group and a second-type data group which are two types of data group that are acquired by different methods;

a data adaptation means which either corrects or reconstructs either first data which belongs to the first-type data group or second data which belongs to the second-type data group and which is associated with the first data, such that a divergence which arises between the first data and the second data because of the difference in the methods for the acquisition thereof is reduced; and

a learning means which, using the data set which includes the corrected or reconstructed data, carries out machine learning.

### (Supplementary Note 2)

The relation search system according to supplementary note 1,

in which the first-type data group is a data group including data obtained by observing or measuring an actual target, and

the second-type data group is a data group including data obtained by computation.

### (Supplementary Note 3)

The relation search system according to supplementary note 1 or 2,

in which the data adaptation means either corrects or reconstructs either the first data or the second data so as to reduce a divergence between the first data and the second data, the divergence being caused by either a parameter fixed or a parameter not taken into consideration in any one of the methods for the acquisition.

### (Supplementary Note 4)

The relation search system according to any one of supplementary notes 1 to 3,

in which both the first-type data group and the second-type data group are data groups including data on material.

### (Supplementary Note 5)

The relation search system according to supplementary note 4,

in which the data set includes at least data indicating a predetermined first property of one or more materials and data indicating two or more predetermined second properties different from the first property of the one or more materials, and

the learning means carries out machine learning using the first property as an output parameter and the two or more second properties as input parameters and outputs information indicating strength of a relation between the first property and the two or more second properties.

### (Supplementary Note 6)

The relation search system according to supplementary note 4 or 5,

in which the second data is data on a material targeted by the first data, or data on a material in an analogous relationship with a material targeted by the first data based on a predetermined rule.

### (Supplementary Note 7)

The relation search system according to any one of supplementary notes 4 to 6,

in which the data adaptation means either corrects or reconstructs either the first data or the second data on the basis of at least one of a difference in constitution of a target material or a difference in an ambient environmental condition between the first data and the second data.

### (Supplementary Note 8)

The relation search system according to supplementary note 7,

in which the difference in the constitution includes a difference in composition or structure.

### (Supplementary Note 9)

The relation search system according to supplementary note 8,

in which the difference in the structure includes a difference in crystal structure or shape.

### (Supplementary Note 10)

The relation search system according to any one of supplementary notes 4 to 9,

in which the data adaptation means reconstructs the second data so as to match the crystal structure of the first data on the basis of the difference in the crystal structure between the first data and the second data of the same composition.

### (Supplementary Note 11)

The relation search system according to supplementary note 10,

in which the data adaptation means identifies the crystal structure of the first data on the basis of clustering processing results of data indicating a third predetermined property, the data matching the first data for the composition and the crystal structure.

### (Supplementary Note 12)

The relation search system according to supplementary note 11,

in which the third property is an X-ray diffraction pattern.

### (Supplementary Note 13)

The relation search system according to any one of supplementary notes 4 to 12,

in which the difference in the ambient environmental condition includes a difference in condition relating to temperature, magnetic field or pressure, or being vacuum or not.

### (Supplementary Note 14)

An information processing device including:

a data adaptation means which either corrects or reconstructs, for a data set which includes a first-type data group and a second-type data group which are two types of data group that are acquired by different methods, either first data which belongs to the first-type data group or second data which belongs to the second-type data group and which is associated with the first data, such that a divergence which arises between the first data and the second data because of the difference in the methods for the acquisition thereof is reduced.

### (Supplementary Note 15)

The information processing device according to supplementary note 14,

in which the first-type data group is a data group including data on material obtained by observing or measuring an actual target,

the second-type data group is a data group including data on material obtained by computation, and

the data adaptation means either corrects or reconstructs either the first data or the second data on the basis of at least one of a difference in constitution of a target material or a difference in an ambient environmental condition between the first data and the second data in the correction or the reconstruction.

### (Supplementary Note 16)

A relation search method, by an information processing device, including:

correcting or reconstructing, for a data set which includes a first-type data group and a second-type data group which are two types of data group that are acquired by different methods, either first data which belongs to the first-type data group or second data which belongs to the second-type data group and which is associated with the first data, such that a divergence which arises between the first data and the second data because of the difference in the methods for the acquisition thereof is reduced; and

carrying out machine learning by using the data set which includes the corrected or reconstructed data.

### (Supplementary Note 17)

The relation search method according to supplementary note 16,

in which the first-type data group is a data group including data on material obtained by observing or measuring an actual target,

the second-type data group is a data group including data on material obtained by computation, and

the information processing device either corrects or reconstructs either the first data or the second data on the basis of at least one of a difference in constitution of a target material or a difference in an ambient environmental condition between the first data and the second data in the correction or the reconstruction.

### (Supplementary Note 18)

A relation search program for causing a computer to execute

processing of correcting or reconstructing, for a data set which includes a first-type data group and a second-type data group which are two types of data group that are acquired by different methods, either first data which belongs to the first-type data group or second data which belongs to the second-type data group and which is associated with the first data, such that a divergence which arises between the first data and the second data because of the difference in the methods for the acquisition thereof is reduced.

### (Supplementary Note 19)

The relation search program according to supplementary note 18,

in which the first-type data group is a data group including data on material obtained by observing or measuring an actual target,

the second-type data group is a data group including data on material obtained by computation, and

the program causes the computer to either correct or reconstruct either the first data or the second data on the basis of at least one of a difference in constitution of a target material or a difference in an ambient environmental condition between the first data and the second data in the correction or the reconstruction.

The present invention of this application has been described above with reference to the present exemplary embodiments and examples, but the present invention of this application is not limited to the above-described exemplary embodiments or the examples. The configurations and details of the present invention of this application can be modified in various ways that can be understood by those skilled in the art within the scope of the present invention of this application.

This application claims priority based on Japanese Patent Application No. 2017-047350, filed on Mar. 13, 2017, the entire disclosure of which is incorporated herein.

### INDUSTRIAL APPLICABILITY

The present invention can be suitably applied to the analysis of each data by applying an information processing technology such as machine learning to a data set including two types of data groups different in acquisition methods.

### REFERENCE SIGNS LIST

10 Relation search system
1 Data storage unit
2 Data adaptation unit
3 Learning unit
20 Material development system
21 Information processing device
211 Crystal structure decision means
212 Computation data conversion means
213 Analysis means
22 Storage device
23 Input device
24 Display device
25 Communication device
1000 Computer
1001 CPU
1002 Main storage device
1003 Auxiliary storage device
1004 Interface
1005 Display device
1006 Input device

1. A relation search system comprising:
a storage unit comprising a first memory configured to store first instructions and a first processor configured to execute the first instructions;
a data adaptation unit comprising a second memory configured to store second instructions and a second processor configured to execute the second instructions; and
a learning unit comprising a third memory configured to store third instructions and a third processor configured to execute the third instructions, wherein
the first memory is configured to store a data set including a first-type data group and a second-type data group, wherein the first-type data group and the second-type data group are acquired by different methods,
the second processor is configured to correct or reconstruct first data belonging to the first-type data group or second data, associated with the first data, belonging to the second-type data group, in order for a divergence between the first data and the second data to be reduced, wherein the divergence arises from the difference in the methods for the acquisition of the first data and the second data, and
the third processor is configured to carry out machine learning using the data set including the corrected or reconstructed data.

2. The relation search system according to claim 1,
wherein the first-type data group is a data group including data obtained by observing or measuring an actual target, and
the second-type data group is a data group including data obtained by computation.

3. The relation search system according to claim 1,
wherein the second processor is configured to correct or reconstruct the first data or the second data so as to reduce a divergence between the first data and the second data, the divergence being caused by a parameter fixed or a parameter not taken into consideration in any one of the methods for the acquisition.

4. The relation search system according to claim 1,
wherein both the first-type data group and the second-type data group are data groups including data on material.

5. The relation search system according to claim 4,
wherein the data set includes at least data indicating a predetermined first property of one or more materials and data indicating two or more predetermined second properties different from the first property of the one or more materials, and
the third processor is configured to carry out machine learning using the first property as an output parameter and the two or more second properties as input parameters and outputs information indicating strength of a relation between the first property and the two or more second properties.

6. The relation search system according to claim 4,
wherein the second data is data on a material targeted by the first data, or data on a material in an analogous relationship with a material targeted by the first data based on a predetermined rule.

7. The relation search system according to claim 4,
wherein the second processor is configured to correct or reconstruct the first data or the second data on the basis of at least one of a difference in constitution of a target material or a difference in an ambient environmental condition between the first data and the second data.

8. An information processing device comprising:
a data adaptation unit comprising a first memory configured to store first instructions and a first processor configured to execute the first instructions, wherein
the first processor is configured to correct or reconstruct, for a data set including a first-type data group and a second-type data group, wherein the first-type data group and the second-type data group are acquired by different methods, first data belonging to the first-type data group or second data, associated with the first data, belonging to the second-type data group, in order for a divergence between the first data and the second data to be reduced, wherein the divergence arises from the difference in the methods for the acquisition of the first data and the second data.

9. A relation search method, by an information processing device, comprising:
correcting or reconstructing, for a data set including a first-type data group and a second-type data group, wherein the first-type data group and the second-type data group are acquired by different methods, first data belonging to the first-type data group or second data, associated with the first data, belonging to the second-type data group, in order for a divergence between the first data and the second data to be reduced, wherein the divergence arises from the difference in the methods for the acquisition of the first data and the second data; and
carrying out machine learning by using the data set including the corrected or reconstructed data.

10. (canceled)

11. The relation search system according to claim 2,
wherein the second processor is configured to correct or reconstruct the first data or the second data so as to reduce a divergence between the first data and the second data, the divergence being caused by a parameter fixed or a parameter not taken into consideration in any one of the methods for the acquisition.

12. The relation search system according to claim 2,
wherein both the first-type data group and the second-type data group are data groups including data on material.

13. The relation search system according to claim 3,
wherein both the first-type data group and the second-type data group are data groups including data on material.

14. The relation search system according to claim 11,
wherein both the first-type data group and the second-type data group are data groups including data on material.

15. The relation search system according to claim 12,
wherein the data set includes at least data indicating a predetermined first property of one or more materials and data indicating two or more predetermined second properties different from the first property of the one or more materials, and
the third processor is configured to carry out machine learning using the first property as an output parameter and the two or more second properties as input parameters and outputs information indicating strength of a relation between the first property and the two or more second properties.

16. The relation search system according to claim 13,
wherein the data set includes at least data indicating a predetermined first property of one or more materials and data indicating two or more predetermined second properties different from the first property of the one or more materials, and
the third processor is configured to carry out machine learning using the first property as an output parameter and the two or more second properties as input parameters and outputs information indicating strength of a relation between the first property and the two or more second properties.

17. The relation search system according to claim 14,
wherein the data set includes at least data indicating a predetermined first property of one or more materials and data indicating two or more predetermined second properties different from the first property of the one or more materials, and
the third processor is configured to carry out machine learning using the first property as an output parameter and the two or more second properties as input parameters and outputs information indicating strength of a relation between the first property and the two or more second properties.

18. The relation search system according to claim 12,
wherein the second data is data on a material targeted by the first data, or data on a material in an analogous relationship with a material targeted by the first data based on a predetermined rule.

19. The relation search system according to claim 13,
wherein the second data is data on a material targeted by the first data, or data on a material in an analogous relationship with a material targeted by the first data based on a predetermined rule.

20. The relation search system according to claim 14,
wherein the second data is data on a material targeted by the first data, or data on a material in an analogous relationship with a material targeted by the first data based on a predetermined rule.

21. The relation search system according to claim 15,
wherein the second data is data on a material targeted by the first data, or data on a material in an analogous relationship with a material targeted by the first data based on a predetermined rule.
